(19) United States
(12) Patent Application Publication
(10) Pub. No.: US 2007/0137610 A1
(43) Pub. Date: Jun. 21, 2007

(54) Rotary engine

(76) Inventor: Barry Hudson, Victoria (AU)

Correspondence Address: Renner Otto Boisselle & Sklar, 1621 Euclid Avenue-Nineteenth Floor, Cleveland, OH, 44115, US

(21) Appl. No.: 10/575,744

(22) PCT Filed: Oct. 10, 2003
(86) PCT No.: PCT/AU03/01344

§ 371 Date: Apr. 10, 2006

(30) Foreign Application Priority Data
Oct. 11, 2002 (AU) 20029252005

(51) Int. Cl. F02B 53/00; F04C 18/00; F04C 2/00

(52) U.S. Cl. 123/246; 418/201.3

(57) ABSTRACT

A rotary engine (2) comprises a housing (16) having a male rotor (4) having a plurality of projecting lobes (12) and a female rotor (8) having a plurality of cavities (14). The male (4) and female rotors (8) are mounted for synchronous rotation about parallel axes such that during rotation successive lobes (12) on the male rotor (4) mate with successive cavities (14) on the female rotor (8) to define therewith a combustion chamber (26) in which a mixture of air and fuel is compressed by the interaction of the lobe (12) and the cavity (14) during rotor rotation. At least one exhaust port (78, 80) leads out of the housing (16) for discharge of exhaust gases from the cavity (14) of the female rotor (8) following combustion and from the space (74) between adjacent lobes (12) of the male rotor (4) following combustion. Respective purge ports (44, 46) lead out of the housing (16) downstream of the exhaust port (78, 80) in the direction of rotor rotation to facilitate discharge of residual exhaust gases from the cavity (14) and inter-lobe space (74), the purge ports (44, 46) being associated with air inlet ports (48, 50) to admit air into the cavity (14) and inter-lobe space (74) in preparation for the subsequent combustion cycle.

### FIELD OF THE INVENTION

The present invention relates to a rotary engine, and more particularly to a rotary engine that produces power from pure rotary motion.

### BACKGROUND OF THE INVENTION

Rotary engines attempt to address many of the problems associated with typical reciprocating engines, such as excessive vibration and noise levels, and wasted energy.

Immense effort has been expended to reduce the vibration in reciprocating engines. In trying to at least partially overcome this vibration, dynamic balancing of the crankshaft assembly is fundamental to this exercise since its action is essentially eccentric. The careful design of the counterweighing of the crankshaft is vital, as is matching the static weights of the pistons, gudgeon pins and conrods. Potentially damaging critical frequency vibration zones, amid the revolution range, are usually changed by adding a harmonic balancer, of a selected mass, to the front of the crankshaft.

Mitsubishi for example, developed an additional chain driven balance shaft to help negate the deleterious sensation of vibration. It is very effective, but it is after the act, and justifiably, absorbs an additional amount of power. It would be much better if a device of this type was not necessary.

In addition to the low frequency vibration associated with reciprocating engines, there is also a substantial amount of higher frequency audible noise generated by the valve drive train. The timing chain, camshaft/s, cam-followers, rockers, tappets, valves and valve springs all contribute to the level of noise emitted.

Reciprocating engines also have a crankshaft with a conrod, gudgeon pin, and piston assembly, which moves through a nearly sinusoidal acceleration—deceleration cycle, from momentarily stationary at the top, to maximum speed in the middle, to stationary at the bottom, to maximum speed again at the middle, to stationary again at the top. One of the major considerations when designing a reciprocating engine is the amount of conrod flex, and this by itself indicates how much energy is needlessly expended.

Rotary gear engines, in particular those having a male rotor with lobes (also referred to herein as teeth) co-operating with a female rotor having cavities, produce power from a relatively pure rotary motion. However, previously proposed rotary gear engines of this type present the additional problem of adequately removing the gases burnt in the combustion phase from the chamber during the exhaust phase, reducing the efficiency of the engine during subsequent combustion cycles.

### SUMMARY OF THE INVENTION

Preferred embodiments of the present invention seek to provide a smooth running, low-vibration, efficient rotary engine that produces its power from pure rotary motion, or at least to provide a useful alternative to previously proposed rotary engines.

In accordance with one aspect of the present invention, there is provided a rotary engine comprising
a housing having a male rotor having a plurality of projecting lobes and a female rotor having a plurality of cavities, the male and female rotors being mounted for synchronous rotation about parallel axes such that during rotation successive lobes on the male rotor mate with successive cavities on the female rotor to define therewith a combustion chamber in which a mixture of air and fuel is compressed by the interaction of the lobe and the cavity during rotor rotation;
at least one exhaust port leading out of the housing for discharge of exhaust gases from the cavity of the female rotor following combustion and from the space between adjacent lobes of the male rotor following combustion; and
respective purge ports leading out of the housing downstream of the exhaust port in the direction of rotor rotation to facilitate discharge of residual exhaust gases from the cavity and inter-lobe space, the purge ports being associated with air inlet ports to admit air into the cavity and inter-lobe space in preparation for the subsequent combustion cycle.

Preferably, the rotary engine comprises a separate exhaust port for the male and female rotor.

Preferably, the purge ports lead radially out of the housing to facilitate the discharge of the residual exhaust gases under the effect of centrifugal force generated by rotor rotation. The purge ports may extend over a relatively large arc of the order of 90° to 120°.

Preferably, the intake ports are located in at least one of two end walls of the rotor housing. More preferably, the intake ports are located in both end walls of the rotor housing.

According to an embodiment of the present invention, the rotary engine may further comprise
a male tip seal for providing sealing contact between the housing and one of said projecting lobes, the male tip seal being provided on the projecting lobe and substantially running along the length of the male rotor; and
a first landing zone provided on the housing following the combustion chamber;
   wherein
   during rotation of the male and female rotors the male tip seal ceases to contact the housing in the region of the combustion chamber, and the first landing zone provides for the gradual re-engagement between the male tip seal and the housing after the male tip seal passes the combustion chamber.

In this form of the invention, the rotary engine may further comprise an element for biasing the male tip seal in a substantially radial direction with respect to the male rotor away from the male rotor towards the housing. The element for biasing the male tip seal may comprise a leaf spring for example.

Preferably, the male tip seal is mounted in a channel provided in the projecting lobe.

Preferably, the male tip seal has a shoulder portion that interacts with an undercut portion in the channel to limit the amount of movement of the male tip seal in a substantially radial direction with respect to the male rotor in the channel.

Preferably, the first landing zone is substantially 4 mm long. In a preferred form of the invention, the first landing zone is in the form of a curved ramp.

According to an embodiment of the present invention, the rotary engine may further comprise
a leading female tip seal for providing sealing contact between the housing and an inter-cavity portion of the female rotor located between successive cavities of the female rotor, the first female tip seal being provided adjacent a leading corner of the inter-cavity portion and substantially running along the length of the female rotor; and
a second landing zone provided on the housing following the combustion chamber;
   wherein
during rotation of the male and female rotors the leading female tip seal ceases to contact the housing in the region of the combustion chamber, and the second landing zone provides for the gradual re-engagement between the leading female tip seal and the housing after the leading female tip seal passes the combustion chamber.

In this form of the invention, the rotary engine may further comprise an element for biasing the leading female tip seal in a substantially radial direction with respect to the female rotor away from the female rotor towards the housing. The element for biasing the leading female tip seal may comprise a leaf spring for example.

Preferably, the leading female tip seal is mounted in a leading channel provided in the inter-cavity portion.

Preferably, the leading female tip seal has a shoulder portion that interacts with an undercut portion in the leading channel to limit the amount of movement of the leading female tip seal in a substantially radial direction with respect to the female rotor in the leading channel.

Preferably, the second landing zone is substantially 4 mm long. In a preferred form of the invention, the second landing zone is in the form of a curved ramp.

According to an embodiment of the present invention, the rotary engine may further comprise a trailing female tip seal for providing a sealing contact between the housing and the inter-cavity portion between successive cavities of the female rotor, the trailing female tip seal being provided adjacent a trailing corner of the inter-cavity portion and substantially running along the length of the female rotor.

Preferably, the rotary engine further comprises an element for biasing the trailing female tip seal substantially away from the female rotor towards the housing. The element for biasing the trailing female tip seal may comprise a leaf spring for example.

Preferably, the trailing female tip seal is mounted in a trailing channel provided in the inter-cavity portion. More preferably the trailing female tip seal has a shoulder portion that interacts with an undercut portion in the trailing channel to limit the amount of movement of the trailing female tip seal in a radial direction with respect to the female rotor in the trailing channel such that the trailing female tip seal does not substantially contact the second landing zone.

According to an embodiment of the present invention, the rotary engine may further comprise a first seal provided in a first channel in the male rotor;
a second seal provided in a second channel of the male rotor, an end of the first channel meeting an end of the second channel; and
a blocking element that is provided where the end of the first channel meets the end of the second channel for preventing exhaust gases entering these channels between the seals and the male rotor and from travelling from one of the first channel and the second channel to the other of the first channel and the second channel.

In this form of the invention, preferably the rotary engine further comprises a blocking biasing element for biasing the blocking element towards the housing away from the male rotor. The blocking biasing element may be a coil spring for example. The blocking element may be substantially a cylindrical shaped stopper. Alternatively, the blocking element may be substantially a piston.

According to an embodiment of the present invention, the rotary engine may further comprise a first seal provided in a first channel in the female rotor;
a second seal provided in a second channel of the female rotor, an end of the first channel meeting an end of the second channel; and
a blocking element that is provided where the end of the first channel meets the end of the second channel for preventing exhaust gases entering these channels between the seals and the female rotor and from travelling from one of the first channel and the second channel to the other of the first channel and the second channel.

In this form of the invention, the rotary engine preferably comprises a blocking biasing element for biasing the blocking element towards the housing away from the female rotor. The blocking biasing element may be a coil spring for example. The blocking element may be substantially a cylindrical shaped stopper. Alternatively, the blocking element may be substantially a piston.

In accordance with a further aspect of the present invention, there is provided a rotary engine comprising
at least one rotor enclosed in a housing, the rotor having at least one tip that contacts a portion of the housing during rotation, the tip ceasing to contact the housing in the region of a combustion chamber as the rotor the tip passes the combustion chamber during rotation of the rotor;
   wherein
a landing zone is provided in the housing to provide for the gradual re-engagement between the tip and said portion of the housing after the tip passes the combustion chamber.

Preferably, the rotary engine further comprises an element for biasing the tip substantially radially with respect to the rotor away from the rotor towards the housing. The element for biasing the tip may comprise a leaf spring for example.

Preferably the tip is mounted in a channel provided in the rotor. Preferably, the tip has a shoulder portion that interacts with an undercut portion in the channel to limit the amount of movement of the tip in a substantially radial direction with respect to the rotor in the channel.

The landing zone may be substantially 4 mm long. The landing zone may be in the form of a curved ramp.

In accordance with a still further aspect of the present invention, there is provided a rotary engine comprising
at least one rotor;
a first seal provided in a first channel in the rotor;
a second seal provided in a second channel of the rotor, an end of the first channel meeting an end of the second channel; and
a blocking element that is provided in the region where the end of the first channel meets the end of second channel for preventing exhaust gases generated during a combustion cycle of the rotary engine from entering said channels between the seals and the rotor.

Preferably, the rotary engine further comprises a blocking biasing element for biasing the blocking element towards the housing away from the rotor. The blocking biasing element may be a coil spring for example. The blocking element may be substantially a cylindrical shaped stopper. Alternatively, the blocking element may be substantially a piston.

### BRIEF DESCRIPTION OF THE DRAWINGS

Embodiments of the present invention will now be described, by way of example only, with reference to the accompanying drawings, in which:

FIG. 1 is an exploded isometric view of a selection of the components of a rotary engine according to an embodiment of the present invention;

FIG. 2 is an end on section view of the engine of FIG. 1;

FIG. 3 is a section view along the longitudinal axis of the male shaft of the engine of FIG. 1;

FIG. 4 is a top plan view of the engine of FIG. 1;

FIG. 5A is an end on section view of the engine of FIG. 1 showing the seal arrays of the male and female rotors;

FIG. 5B is view of section A-A of FIG. 5A;

FIG. 5C is view of section B-B of FIG. 5A;

FIG. 5D is view of section C-C of FIG. 5B showing a tip seal fitted to a tooth of the male rotor;

FIG. 6 is a section view of the landing zone provided in the housing of the engine of FIG. 1 for the tip seals of the male rotor;

FIG. 7 is a section view of the landing zone provided in the housing of the engine of FIG. 1 for the leading tip seals of the female rotor;

FIG. 8 is a section view of a spark plug of the engine of FIG. 1;

FIG. 9 is a schematic axial section view showing the operation of a rotary engine according to an embodiment of the present invention;

FIG. 10 shows a series of graphs of theoretical torque on a tooth of the male drive shaft rotor verses shaft angle for a range of male rotor root diameters, tooth depths and tooth widths in accordance with an embodiment of the present invention;

FIG. 11 shows a graph of torque verses drive shaft angle for both the engine of FIG. 1 and a comparably sized reciprocating engine; and

FIG. 12 shows a graph of engine capacity against male rotor root diameter for a rotary engine according to an embodiment of the present invention.

### DETAILED DESCRIPTION

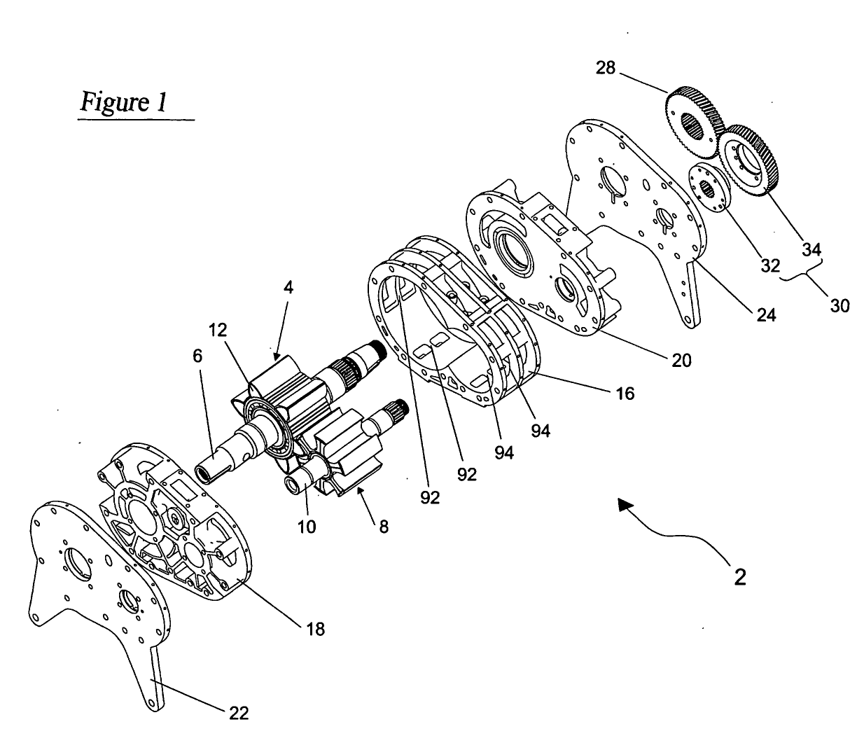

In FIGS. 1 to 8, a rotary engine 2 according to an embodiment of the present invention is shown. The engine 2 includes a male rotor 4 mounted on a male drive shaft 6, and a female rotor 8 mounted on a female shaft 10. The male rotor 4 has six projecting lobes or teeth 12, while the female rotor 8 has six cavities 14 for receiving the projecting teeth 12. The rotors 4, 8 and shafts 6, 10 are enclosed within a binocular shaped main housing 16 at either end by end plates 18, 20 and respective cover plates 22, 24.

The shafts 6, 10 are aligned to allow for synchronous rotation of the respective male 4 and female rotors 8 about parallel axes such that during rotation of the shafts 6, 10 successive teeth 12 of the male rotor 4 mate with successive cavities 14 of the female rotor 8 to define a combustion chamber 26 in which a mixture of air and fuel may be compressed. A pair of helical timing gears 28, 30 further having an 18° helical lead angle that engage via involute splines maintain synchronisation of the shafts 6, 10 during rotation to reduce rotor-clash. The helical gears 28, 30 assist in the prevention of rotor-clash by introducing a small amount of radial adjustment of the rotors 4, 8. The helical gears have also been found to be quieter than spur gears for example.

The female gear 30 includes a hub 32 mounted on involute splines, and a ring gear 34 doweled and screwed to the hub 32. The gears 28, 30 are also adjusted linearly with respect to each other by the addition of shims (not shown) between the hub 32 and the ring gear 34. This system has been used successfully to prevent rotor-clash in roots type superchargers.

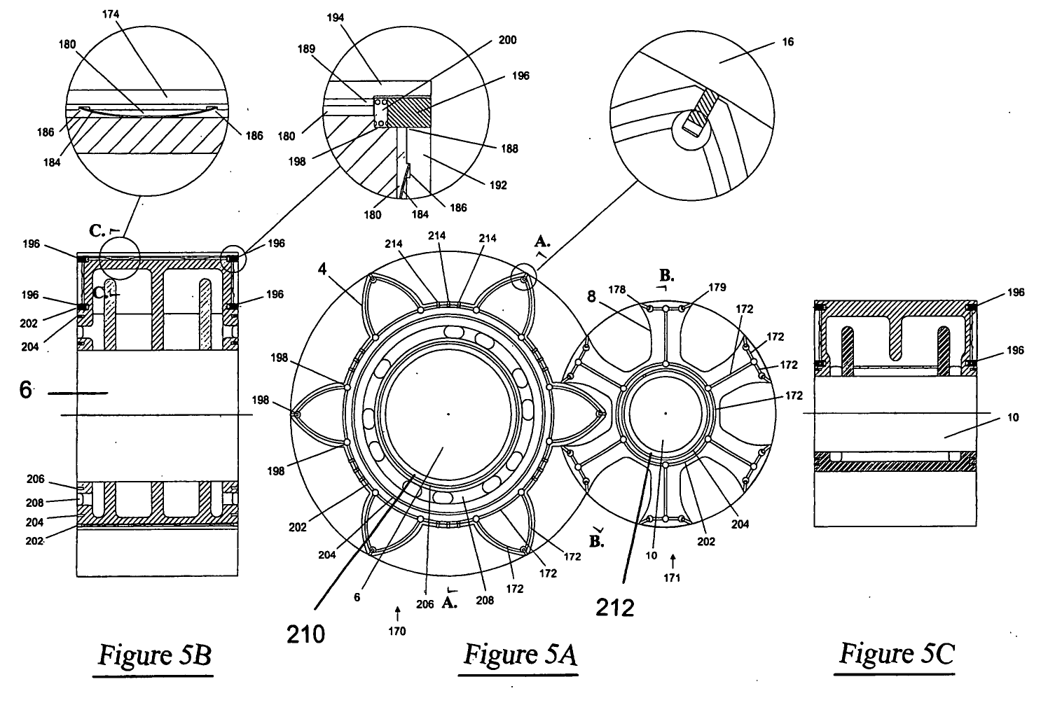

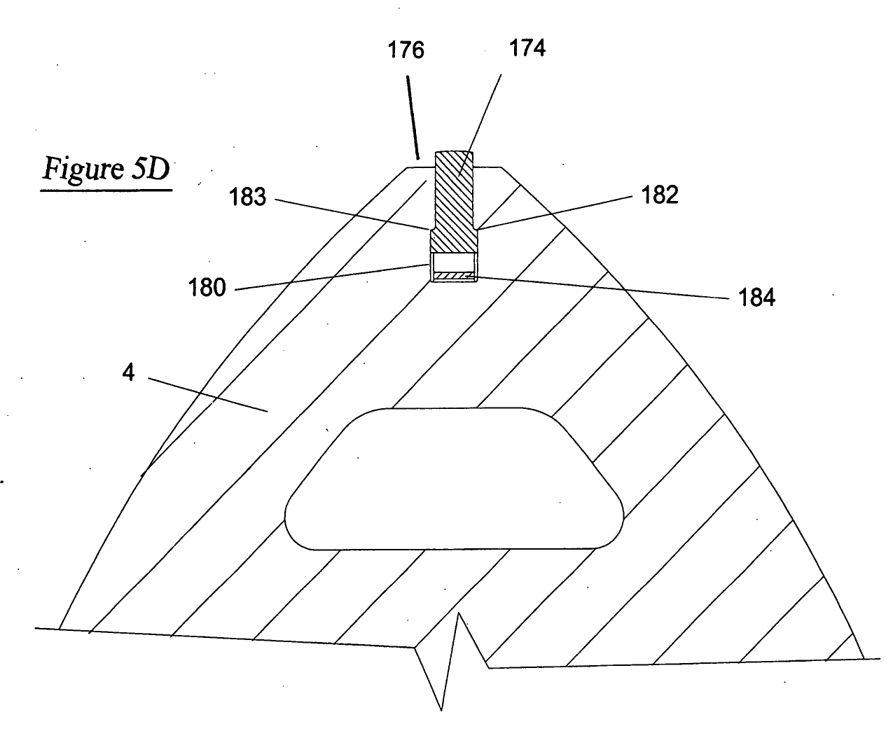

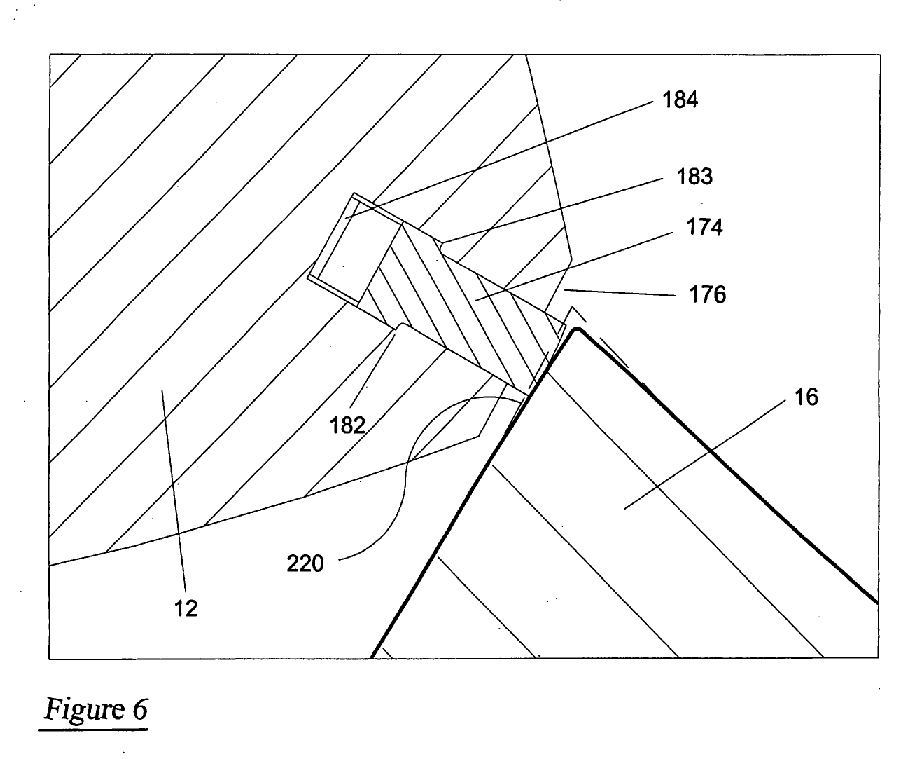

The amount of radial excursion of the rotors 4, 8 is dependent on the degree of backlash in the gears 28, 30 and the linear movement of the shafts 6, 10 due to end thrust. The end thrust will be taken between the rotor end faces and the end plates 18, 20. The end clearance between the male 4 and female rotors 8 and the end plates 18, 20 is about 0.1 mm. The variation of rotor orientation caused by backlash in the gears 28, 30 and end thrust variation is absorbed by spring-loaded tip seals 178, 179 of the female rotor 8 (shown in FIGS. 5A and 5C).

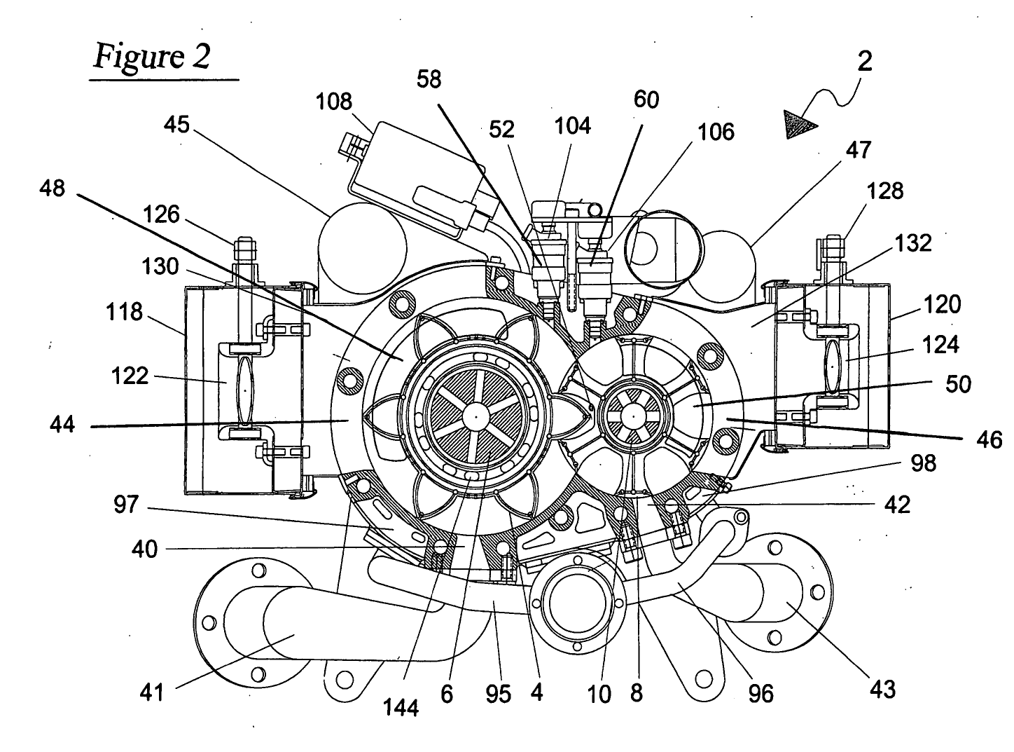

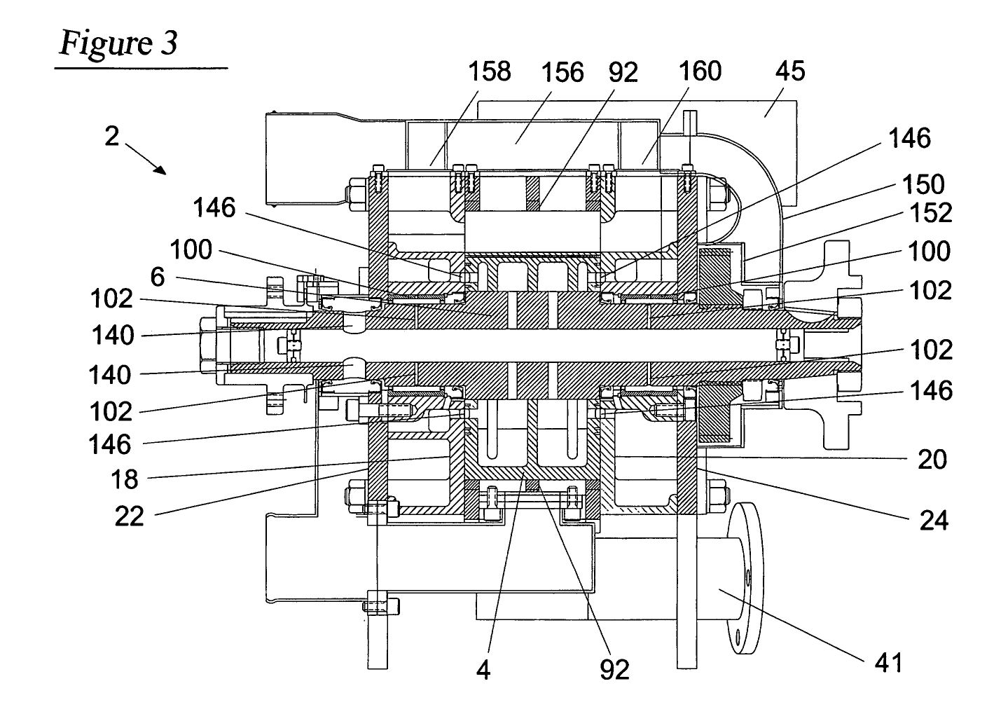

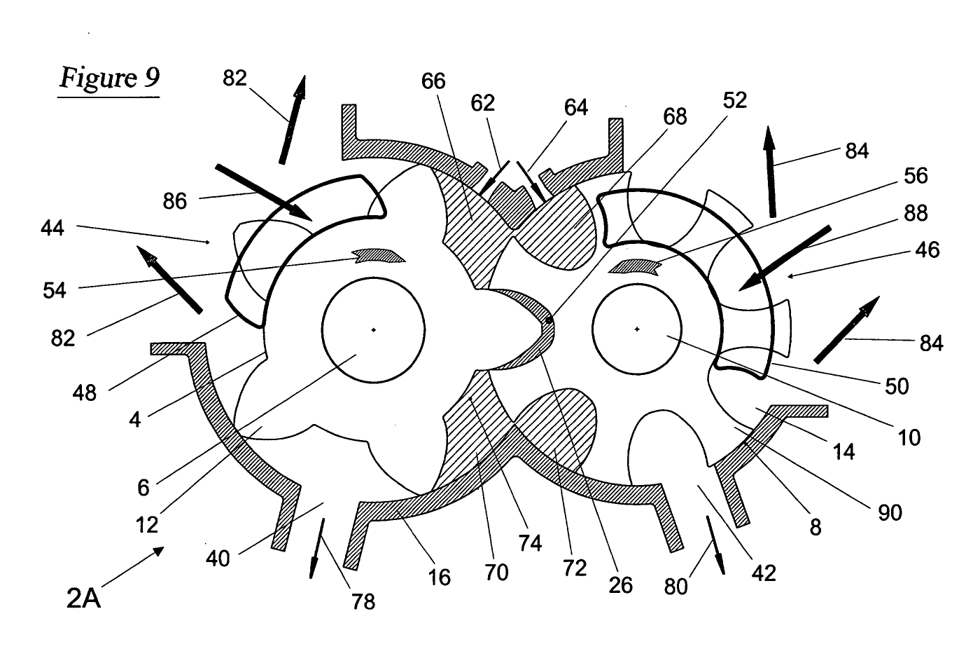

With reference to FIGS. 2 and 3, the housing 16 has at least one exhaust port, with the rotary engine 2 having male 40 and female exhaust ports 42 leading out of the housing 16 to respective male 41 and female exhaust manifolds 43 for the discharge of exhaust gases, and male 44 and female purge ports 46 leading out of the housing 16 to respective male 45 and female purge ducts 47 downstream of the respective exhaust ports 40, 42 in the respective directions of male 4 and female 8 rotor rotation to facilitate discharge of residual exhaust gases. The purge ports 44, 46 provided in the housing 16 are quite long and large, and may extend for example over a relatively large arc of the order of 90° to 120°. Male 48 and female inlet ports 50 are provided in each of the respective end plates 18, 20 for the intake of air. While FIG. 2 is an axial section view of the engine 2, the male 48 and female inlet ports 50 which are provided in each of the respective end plates 18, 20 have been indicated in FIG. 2 (and similarly in FIG. 9) for the purposes of describing the operation of the rotary engine 2 according to an embodiment of the present invention. A spark plug 52 is located in each end plate 18, 20.

The cycles of the rotary engine 2 will be described with reference to FIG. 9, which shows a schematic axial section view of a rotary engine 2A according to an embodiment of the present invention. It will be appreciated that the engine 2A shown in FIG. 9 differs from that shown in FIGS. 1 to 8 in that the engine 2A has an alternative arrangement, comprising male and female rotors having five teeth 12 and seven cavities 14 respectively. The same reference numerals will be used to refer to the same components.

The rotors 4, 8 rotate in opposing directions as indicated by respective arrows 54 and 56. Air is taken in during an air-fuel intake cycle through intake ports 48, 50 in the end plates 18, 20. Fuel is injected by male and female fuel injectors 58, 60 as indicated by respective arrows 62 and 64 to form an air-fuel mixture during the early stage of the compression cycle that takes place in the respective regions 66, 68. As the rotors 4, 8 further rotate, the air-fuel mixture is trapped and compressed between a male tooth 12 of the male rotor 4 and a cavity 14 of the female rotor 8. Maximum compression is reached when a tooth 12 of the male rotor 4 is aligned with, and received in, a cavity 14 in the female rotor 8. The spark plugs 52 located at each end of the formed combustion chamber 26 fire simultaneously causing the air-fuel mixture to ignite. A retard/advance system (not shown) can be used to control the simultaneous firing of the spark plugs 52, such that the spark plugs 52 may fire late when the engine 2 is being started and early when the engine 2 is revving highly. Ignition of the air-fuel mixture initiates the expansion cycle in which the expansion of the gasses raises the pressure in the chamber 26, forcing a reaction between the rotors 4, 8. The tooth 12 on the male rotor 4 reacts against the cavity 14 of the female rotor 8, such that the male rotor 4 obtains an offset from the female rotor 8, and imparts torque to the male drive shaft 6. The female rotor 8 is the reactive element and does not exert torque on the female shaft 10, as the geometry of the female rotor 8 does not constitute the necessary offset. The pressure exerted on the female rotor 8 is absorbed in all directions equally, and is transferred radially to the female shaft 10.

The volumes 70, 72 defined between the tooth 12 of the male rotor 4, the cavity 14 of the female rotor 8 and the housing 16 during the expansion cycle expand as the shafts 6, 10 rotate until maximum volumes are reached. When the inter-teeth space 74 between successive teeth 12 of the male rotor 4 and the cavity 14 of the female rotor reach the male 40 and female exhaust ports 42 respectively in the main housing 16, as part of the exhaust cycle, the residual pressure in this inter-teeth space 74 and cavity 14 forces the burnt exhaust gases trapped therein to be released into respective exhaust ports 40, 42 as indicated by respective arrows 78, 80.

The inter-teeth space 74 between successive teeth 12 and the cavity 14 still contain residual burnt exhaust gases however. As rotation progresses, the inter-teeth space 74 and cavity 14 in the male 4 and female rotors 8 respectively each reach the respective male 44 and female purge ports 46 in the main housing 16. The rotation of both the male 4 and female rotors 8 results in a substantive portion of the remaining burnt exhaust gases in the inter-teeth space 74 and the cavity 14 being centrifugally thrust out respective purge ports 44, 46 as indicated by respective arrows 82, 84 as part of a purging cycle. The inter-teeth spaces 74 between successive teeth 12 of the male rotor 4 and the cavities 14 of the female rotor 8 rotate past the male 48 and female inlet ports 50 which admit clean air. The inlet ports 48, 50 partially overlap purge ports 44, 46 respectively. The centrifugal purging action of the burnt exhaust gases moving radially outward as indicated by arrows 82, 84 lowers the pressures in the inter-teeth space 74 and the cavity 14 causing clean air to be drawn in through the respective inlet ports 48, 50 in the respective end plates 18, 20 as indicated by respective arrows 86, 88 as part of the air-fuel intake cycle. The inter-teeth space 74 and the cavity 14 then pass the end of the respective purge ports 44, 46 and the respective inlet ports 48, 50. The clean inlet air is then again confined by the main housing 16, and fuel is again injected during the early stages of the compression cycle.

All five cycles, the air-fuel mixture intake, the compression, the expansion, the exhaust and the purging, are happening simultaneously, and each mating tooth 12/cavity 14 pair fire every revolution. The overlapping of the compression cycle of a trailing tooth 12/cavity 14 pair with the expansion cycle of an adjacent leading tooth 12/cavity 14 pair smoothes the output of the rotary engine 2.

It will be appreciated the various ratios of the number of cavities 14 to teeth 12, and number of teeth 12 provided on the male rotor 4 will operate satisfactorily. The selection of these is governed by the width of the inter-cavity portions 90 between the cavities 14 of the female rotor 8 at the narrowest point of these inter-cavity portions 90. The width of these inter-cavity portions 90 is governed by the their depth, which is in turn governed by the maximum depth of the teeth 12 of the male rotor 4, which is in turn governed by the number of teeth 12 provided on the male rotor 4. For a male rotor 4 having six teeth 12 for example, the tooth pitch is set at 60° for the six teeth 12, and for a given diameter and tooth depth, a minimum male tooth tip width allows the maximisation of the volumetric capacity. For a given diameter, a larger number of teeth 12 requires a smaller tooth depth. Excessive tooth depth of the teeth 12 of the male rotor 4 requires an undercut at the root of the teeth 12 of the male rotor 4. Optimum tooth depth has been found to occur at the point where this undercut is reduced to zero.

It has been found that the 2:1 ratio of cavities 14 to teeth 12 for example allows equal diameter male 4 and female rotors 8, and a maximum tooth depth that is one third of the radius of the rotors 4, 8. As the ratio approaches 1:1, the outside diameter of the female rotor 8 reduces relative to the diameter of the male rotor 4. At a ratio of 1:1 the maximum outside diameter of the female rotor 8 has been found to be equal to the root diameter of the male rotor 4, maximum tooth depth has been found to be substantially 0.3 of the radius of the male rotor 4.

The described engine 2 shown in FIGS. 1 to 8 having a 1:1 ratio with six teeth 12 provided on the male rotor 4 has been found to be quite practical, allowing a relatively long purge cycle when compared to engines having male rotors having less than six teeth 12. Further, six teeth 12 provide satisfactorily wide inter-cavity portions 90 (or female teeth), and large enough root diameters of the male 4 and female rotors 8 to permit suitable shaft 6, 10 sizes and end sealing. In any case, it has been found that five teeth 12 are the minimum necessary for a normally aspirated engine 2.

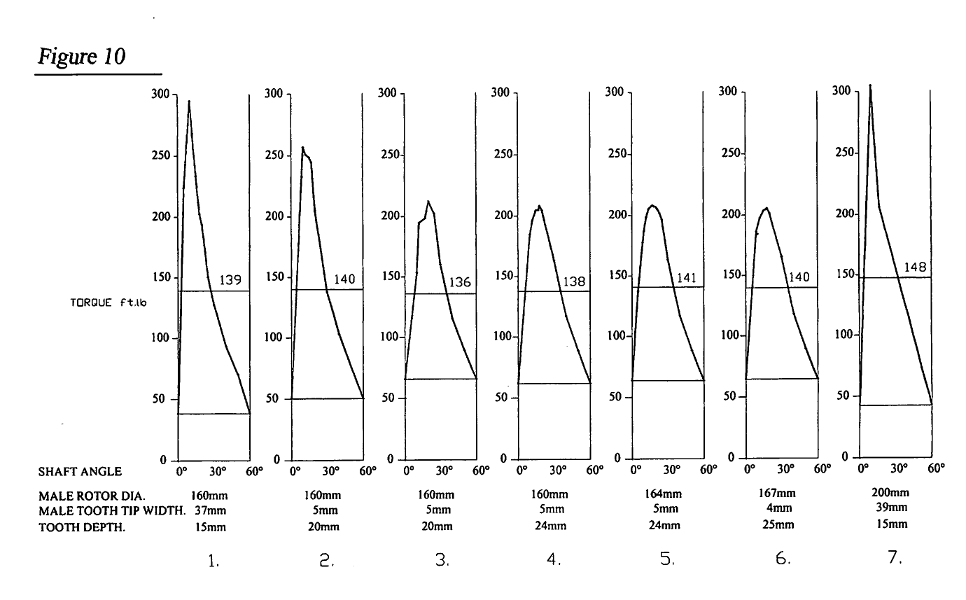

For the purposes of developing the 1:1 ratio six tooth engine 2 according to an embodiment of the present invention, the theoretical torque and pressure acting on the teeth 12 of the male rotor 4 were first calculated to determine the proportions of the male rotor 14 and the tooth size. As the pressure and torque calculations were based on P₁·V₁=P₂·V₂ rather than an Indicator Diagram (the compression ratio had yet to be determined), the calculations provided a comparison only and not an indication of eventual performance. The theoretical torque generated on the male drive shaft 6 was plotted against the shaft angle of the male rotor 4 with the length of the male rotor 4 being varied from 150 mm to 200 mm, with a number of tooth depths and widths. The tooth depth influences the profiles and the pitch between the rotor 4, 8 centres and consequently the overall length of the rotors 4, 8. The results are summarised in the graphs shown in FIG. 10.

The graphs in FIG. 10 show that the overall torque output does not vary significantly over a variety of configurations. The wide shallow tooth 12 (see graphs 1 and 7 in FIG. 10) does however result in the undesirable characteristic of a very high peak early in the cycle. It is far more advantageous for the torque curve to be as flat and smooth as possible (for example graph 5 of FIG. 10), and as such as a basis for development, a male rotor 4 having a profile, in this instance, with a diameter of 164 mm, a relatively narrow male tooth tip (5 mm) and as large a tooth depth as possible (24 mm), without undercut, was preferable.

The longer the rotors 4, 8 are, the smaller the diameters of the rotors 4, 8 may be for a given capacity. The length of the male rotor 4 is also governed by the placement of substantially central bridges 92, 94, as indicated in FIGS. 1 and 3, to support the later described tip seals 174, 178, 179 as they cross the exhaust ports 40, 42 and the purge ports 44, 46. Advantageously these bridges 92, 94 would include an orifice to allow coolant to flow through them. The rotary engine 2 has bridges 92, 94 which do not include a cooling orifice. As a result, two additional oil cooling inlet branch pipes 95, 96 are provided to cool the isolated pockets indicated by arrows 97, 98 in the main housing 16 on the outside of the male 40 and female exhaust ports 42.

The profiles of the teeth 12 of the male rotor 4 were generated by the path described by a locus, at the intersection of the outside diameters of the male 4 and female rotors 8, as the rotors 4, 8 revolve. The profile of the cavities 14 of the female rotor 8 are then expanded in volume to realise the desired compression ratio. The compression ratio is determined at maximum compression at ‘top dead centre’. Top dead centre is the rotation point where a male tooth 12 is fully engaged in a female cavity 14, thereby defining the compression chamber 26. The profile of the teeth 12 is similar to that utilised in screw compressors and is generally known as a “generated profile”.

The main housing 16 of the engine 2 is fabricated from bright mild steel components welded together. The housing 16 is machined and the inside surface case hardened to 65 Rockwell C with a final fine grind. Alternatively, the main housing 16 may be formed form other materials, such as for example cast aluminium.

The end plates 18, 20 are produced by investment casting off steriolithographic master wax models from 3D CAD solid models, and are hard chromed and ground. This method allows undercuts and wall thickness down to 3 mm. Alternatively for example, the end plates 18, 20 may be formed from cast aluminium machined with a hard-face coating.

The end plates 18, 20 each have two bearings 100 carrying the shafts 6, 10. 50 mm diameter×35 mm long single row roller bearings having a dynamic rating of 4,400 kilograms are provided at either end of the male drive shaft 6. The nominal limit is 8,000 rpm, however by providing a radial clearance close to the maximum 25 microns it is expected the bearings should be able to withstand short excursions into the 10,000 rpm range. 32 mm diameter×30 mm long single row roller bearings having a dynamic rating of 2,950 kilograms and a nominal limit of 12,000 rpm are provided at either end of the female shaft 10. All four bearings 100 run directly on the shafts 6, 10 without inner races.

The male shaft 6 is simplified by both the use of these longer, single-row, 50 mm diameter, needle roller bearings 100 on both journals and oil cooling. Oil cooling simplifies the bearing lubrication holes 102 and improves the shaft 6 (or 10) to rotor 4 (8) oil transfer.

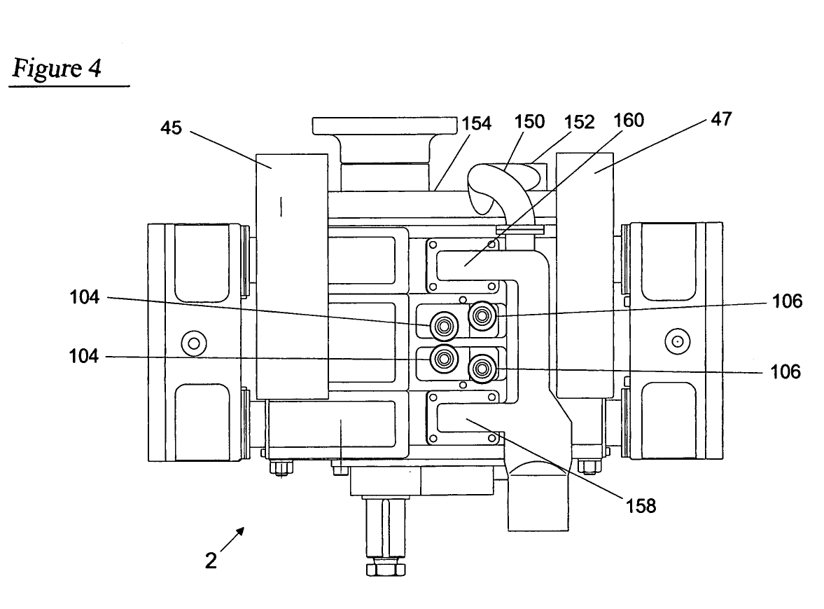

For the injection of fuel during the early stages of the compression cycle, there are two male fuel injectors 104 associated with the male rotor 6 and two female fuel injectors 106 associated with the female rotor 8. The two male fuel injectors 104 are set lean, while the two female fuel injectors 106, which impart a smaller volume charge, are set rich. The female fuel injectors 106 are spaced wider apart than the male injectors 104 (as shown in FIG. 4) to impart their charge in the region of the spark plugs 52. This provides a form of stratified charge. The smaller rich charge, which is closer to the spark plugs 52 and is far more readily ignited than the larger lean charge, acts as a detonator for the lean mixture fed in by the male injectors 104.

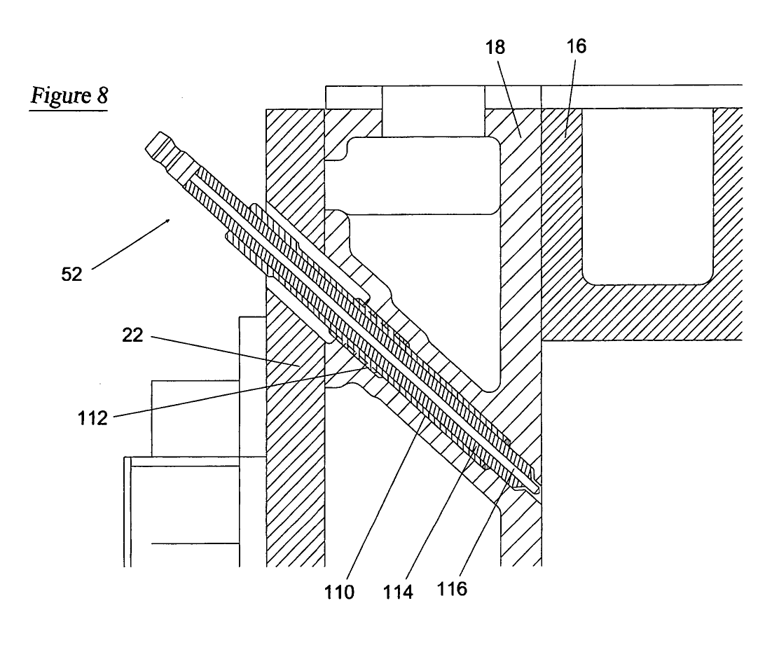

A dual output coil 108 simultaneously fires the specially designed spark plugs 52 which are located at the end plates 18, 20 at each end of the combustion chamber 26 formed in the housing 16 between a mating tooth 12 and cavity 14 near the centre of the engine 2 at the appropriate time. As shown in FIG. 8, the spark plugs 52 are constructed with a combined strengthening tube 110 and clamp screw 112 adhered with ceramic adhesive over an alumina ceramic tube 114, with an electrode 116 similarly adhered through the centre of the tube 114. While conventional spark plugs may be utilised, it has been found very awkward to position the plugs that far down, even with extra long reach plugs, and the resulting combustion space was too large. It is considered that the 8 mm diameter surface discharge plugs presently being used in F1 engines may provide an alternative solution.

The air is introduced through male 118 and female air cleaners 120 having respective throttles 122, 124 controlled by respective throttle levers 126, 128 mounted on male and female plenum chambers 130, 132 on each side of the engine. Male and female inlet manifolds connect the plenum chambers 130, 132 to four inlet galleries (not shown), two in each of the end plates 18, 20. These male and female inlet galleries in each endplate 18, 20 leading to the inlet ports 48, 50, form part of the fifth purging cycle, allowing clean air to replenish each inter-teeth space 74 between successive teeth 12 and each female cavity 14 from which the exhaust gases are successively purged.

While the fifth purging cycle may leave a very small residue of burnt exhaust gas in the inter-teeth spaces 74 and the cavities 14, it is noted that some engine manufacturers deliberately reintroduce up to 11% of burnt exhaust gas to lower the combustion temperature from 3300° F. to about 3000° F. as one method to reduce NOx emissions.

It is thought that the exhaust gases will contain a higher hydrocarbon (HC) content for several reasons. Fuel injecting this late before ignition will not allow much time for evaporation so a portion of the fuel will still be in atomised droplet form. There will also be an amount of ‘wetting out’ on the walls and in the corners of the formed combustion chamber 26. The formed combustion chamber 26 has sharp corners, which causes ‘shading’ and consequently a degree of incomplete combustion. There is also a lubricating oil content added to the fuel or injected into the inlet air of the rotary engine 2, which will also result in additional hydrocarbon and solids in the exhaust. It is thought that the resultant emissions will be roughly equivalent to those of the later Mazda rotary engines.

The amount of cooling of the rotary engine 2 that will be necessary is dependent on the amount of fuel burnt. This in turn is a factor of the thermal efficiency of the engine 2 and the horsepower produced. The current heat value for typical fuel is 44 Mega-Jules per kilogram. The expected fuel usage of the 1:1 ratio six teeth 1000 cc capacity engine 2 is 0.23 kg of fuel per kW of power delivered per hour. It is anticipated that the engine 2 will deliver about 70 kW of power at 3500 RPM. This would indicate a fuel usage of 0.268 litres per minute, which equates to a total heat input of 196.5 kW per minute. In a normal reciprocating engine, approximately 5% of this would be unburnt fuel, 30% discharged in the exhaust gasses, 30% absorbed by the combustion chamber and pistons and the remainder is useful power output. The 30% absorbed would correspond to 64.8 kW per minute which needs to be addressed by the cooling system.

The combustion chamber, valves, cylinder walls and piston crown of a substantially equivalent 2000 cc capacity four cylinder reciprocating engine has a combined area of 143,760 mm², while the rotary engine 2 has an equivalent heat absorption area of 104,420 mm². Hence, the engine 2 has approximately 27% less thermal absorption area than its reciprocating counterpart. This will result in an increase in thermal efficiency. This means that the 30% figure for absorption could be reduced to about 22%, which gives the cooling system 47.5 kW per minute to contend with. The difference is the gain in thermal efficiency.

The engine 2 is oil cooled. Oil has a specific heat about half that of water. Even with double the throughput, it is expected that the engine would still run hotter than one alternatively water cooled. In an alternative preferable form, the engine 2 would be water cooled. The oil cooled engine 2 simplifies the design considerably however, by eliminating the requirement for a water pump and associated heat exchanger, leaving just the oil pump with a larger heat exchanger. The oil inlet ports 140 to the shafts 6, 10 and rotors 4, 8 are one-way instead of the two-way water system. The bearings 100 are lubricated directly from the shafts 6, 10. The male rotor cooling and lubrication oil are introduced through the centre of the male drive shaft 6. The male rotor cooling outlets are a series of slots 144 in the end faces of the male rotor 4 with matching slots 146 in the end plates 18, 20. The rotor cooling oil transfers through these slots 146 into the end plates 18, 20 and combines with the housing cooling in a series of galleries 148. The female rotor 8 cooling and lubrication oil is also introduced through the centre of the female shaft 10. The outlet 150 is through an end of the shaft 10, passing through a cover 152 of the timing gear housing 154 and up into the cooling oil outlet manifold 156. This allows one common oil outlet manifold 156. FIGS. 3 and 4 show the oil outlet 150 from the timing gear cover 152 extending upward and joining the main oil outlet manifold 156. The main oil outlet manifold 156 also receives oil from the two end plates 18, 20 via two ports 158, 160.

The use of an electric pump (not shown), with a maximum delivery rate of 1.2 litres per second, with an electronic speed controller automatically varies the flow rate of the cooling oil to maintain the outlet temperature at about 100° C. (212° F.). An aluminium radiator (not shown) fitted with a thermally controlled fan is used as the heat exchanger. This radiator is twice the size of a radiator that would be needed for a water-cooled engine.

The cooling is introduced to the hot areas in the housing 16; first the exhaust ports 40, 42 and then the combustion area. Since combustion takes place six times per revolution, once for each of the six teeth 12, heat absorption by the housing 16 and the exhaust ports 40, 42 is almost continuous. The hot oil is then distributed to some of the cooler areas.

The rotors 4, 8 rotate through cold air induction to the heat generated by the compression, combustion and expansion cycles. The rotors 4, 8 obtain a small respite from the heat during the induction cycle, where they are additionally cooled during the purge cycle by the centrifugal induction of cool air. The housing 16 has no respite. For this reason, most of the cooling is directed to the housing 16. It does not matter how hot the housing 16 gets, if the temperature is even over the whole expanse.

In order to contain the high-pressure gasses in both the individual cavities of the female rotor and the inter-teeth spaces between successive teeth of the male rotor, a plurality of seals forming the male 170 and female “seal arrays” 171 shown in FIG. 5A to 7 are employed.

End seals 172 are provided on the ends of both the male 4 and female rotors 8 adjacent the respective end plates 18, 20 to provide a moving sealing contact with the respective end plates 18, 20. On the male rotor 4 these seals 172 substantially follow the root diameter of the male rotor 4 and the profile of the teeth 12. On the female rotor 8, these seals 172 substantially follow the root diameter of the female rotor 8 and the inter-cavity portions 90.

Male tip seals 174 are provided on the apices 176 of the teeth 12 of the male rotor 4 to provide a moving sealing contact with the housing 16. A leading female tip seal 178 and a trailing female tip seal 179 are similarly provided on a leading corner and a trailing corner respectively in the direction of rotation on each inter-cavity portion 90 between the cavities 14 of the female rotor 8 to substantially provide a moving sealing contact with the housing 16.

These end seals 172 and tip seals 174, 178, 179 are manufactured from nitridable strips having a cross sectional area of 1.2 mm×2.5 mm. These strips are machined at each end to fit into 3.5 mm deep seal channels 180 provided on the rotors 4, 8 with a small end clearance being provided to allow for thermal expansion. As the rotors 4, 8 rotate it is necessary to limit the radial outward movement of the male 174 and female tip seals 178, 179 in the region of the combustion chamber 26 where there is a gap in the housing 16. The movement of the male 174 and female tip seals 178, 179 is limited for example to approximately 0.15 mm by small shoulders 182, 183, forming a “tee”, on the inside faces of the tip seals 174, 178, 179 that interact with small undercuts in the base of the seal channels 180 in the rotors 4, 8. The edges of the tip seals 174, 178, 179 are also nitrided to enable them to withstand the battering as they cease contact and re-engage with the housing 16 every rotation of the rotors 4, 8.

Bias elements in the form of leaf springs 184 to bias the end 172 and tip seals 174, 178, 179 away from the male 4 and female rotors 8. The leaf springs 184 act on the end seals 172 such that they impart an outward pressure away from the rotors 4, 8 against the hard chromed and ground end plates 18, 20. The leaf springs 184 act on the male tip seals 174 and female leading 178 and trailing tip seals 179 such that they impart an outward pressure away from the rotors 4, 8 against the case hardened and ground housing 16. The leaf springs 184 are located in the channels 180 and are aligned with the seals 172, 174, 178, 179 by small notches 186. This distance between these notches 186, the distance between leaf springs 184 and the distance these leaf springs 184 are located from the ends of each seal 172, 174, 178, 179 can be all used to set the balance of the pressure of the seals 172, 174, 178, 179.

In the joining regions 188, 189 (for example) were the ends of two adjacent seals 192, 194 (for example) meet, blocking elements or cylindrical stoppers in the form of pistons 196 are provided to prevent the high-pressure gases entering the formed chambers via the channels 180 via the 1 mm gap under the end seals 172 and the tip seals 174, 178, 179 in which the leaf springs 184 operate.

The pistons 196 penetrate 1 mm deeper than the bottom of the seal channels 180 to limit the free passage of high-pressure gases between successive inter-teeth spaces 74 of the male rotor 4 and successive cavities 14 of the female rotor 18. In the described engine 2, the pistons 196 are 3.2 mm diameter phosphor-bronze pistons located in holes 198 in the regions 188, 190 where adjacent seals 192, 194 meet. Bias elements in the form of small coil springs 200 bias the pistons 196 such that they impart outward pressure against the hard chromed and ground end plates 18, 20.

Both the male 4 and female rotors 8 have two circular compression rings 202, 204 at each end of the rotors 4, 8. Circular leaf springs in channels (both not shown) formed in the rotors underneath these compression rings 202, 204 bias the rings 202, 204 towards the end plates 18, 20. The male rotor 4 also has an extra ring seal 206 located adjacent to and inside an oil outlet groove 208 provided on the male rotor 4 to limit passage of the oil and bypass gas inward toward the male drive shaft 6. The oil and bypass gas that does pass this ring seal 206 is allowed to collect in an annular recess 210 around the shaft 6. This oil and bypass gas is then allowed to vent into the end plates 18, 20 where it mixes with the main cooling oil volume. The gas may be separated from the oil in a swirl tank (not shown) after an intercooler (not shown). A similar annular recess 212 is provided around the shaft 10 of the female rotor 8.

As shown in FIG. 5A, three additional “tee” seals 214 are located in each inter-teeth space 74 on the root diameter of the male rotor 4. These seals 214 prevent leakage of the high-pressure gases while the outside diameter of the female rotor 8 is adjacent to the root diameter of the male rotor 4 during the later stages of the combustion cycle and the early stages of the expansion cycle. Each of the tee seals 214 has two leaf springs 184, identical to those used under the end 172 and tip seals 174, 178, 179. The two springs 184 are similarly each located by four small notches 186 in each tee seal 214. In an alternative arrangement, it is considered that the male rotor 4 could be designed with only two of these tee seals 214 being provided in each inter-teeth space 74 of the male rotor 4.

Male 220 and females landing zones 222 associated with the male 174 and female leading tip seals 178 respectively are provided in the housing 16 downstream of the formed combustion chamber 26. As recited above, as the male 4 and female rotors 8 rotate, these tip seals 174, 178 cease to contact the housing 16 in the region of the combustion chamber 26 where there is a gap in the housing 16. They pass across this gap and are biased by the leaf springs 184, and centrifugally cast by the rotary motion of the rotors 4, 8, into the gap. These “flying” seals 174, 178 need to land again after they cross the gap.

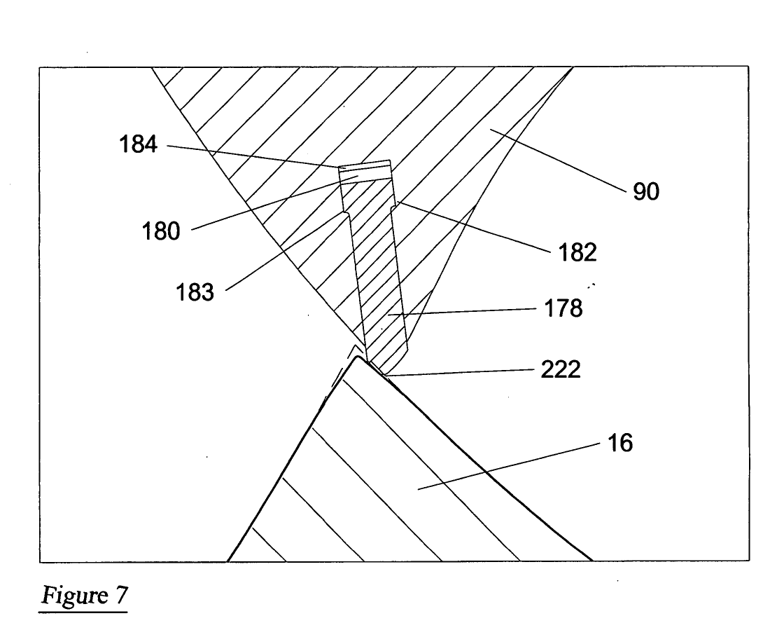

The male landing zone 220 and the female landing zone 222, as shown in FIGS. 6 and 7, are provided in the housing 16 to soften this landing, and to provide for the gradual re-engagement between the tip seals 174, 178 and the housing 16. In one embodiment, these landings 220, 222 are provided by 4 mm long curved ramps machined into the profile of the main housing 16 for example.

FIG. 6 shows the male landing zone 220. In FIG. 6, for the purposes of clarity, the female rotor 8 and the trailing female tip seal 179 provided on the female rotor 8 have not been shown. The male landing zone 220 provided on the housing following the combustion chamber 26 (not shown in this in FIG. 6) in the direction of rotation of the male rotor 4 provides for the gradual re-engagement between the male tip seal 174 and the housing 16 after the male tip seal 174 passes the combustion chamber 26.

FIG. 7 similarly shows the female landing zone 222. The female landing zone 222 provides for the gradual re-engagement between the leading female tip seal 178 and the housing 16 after the female tip seal 178 passes the combustion chamber 26.

The outward movement of each trailing female rotor tip seal 179 is limited so that it does not extensively cast out into the gap of the housing 16 during rotation. This prevents each trailing female seal contacting the female landing zone, to prevent the trailing female seals 179 from being dislodged from corresponding channels 180 formed in the inter-cavity portions 90.

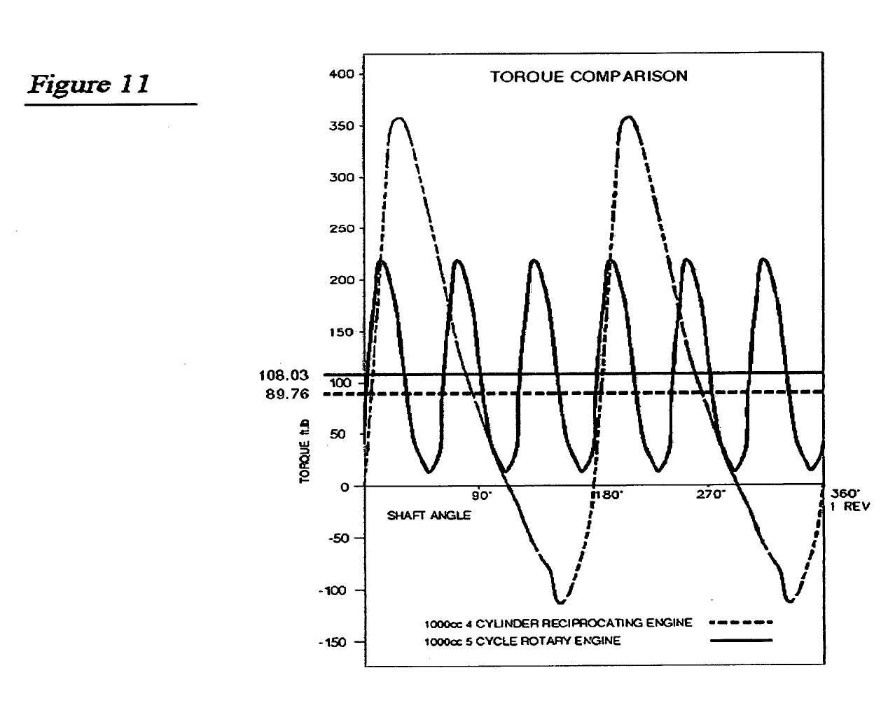

A comparison of the 1000 cc 1:1 ratio six teeth having the described five cycle engine 2 was made with a four-cylinder 2000 cc reciprocating engine, with substantially the same parameters used for both. The torque output of both engines was calculated at various incremental points during a full revolution. The results are shown in the graph shown in FIG. 11. The pressure in the combustion chamber 26, at the progressive degrees of drive shaft rotation from top dead centre was determined from an Indicator Diagram, which represents the chamber pressure in a typical reciprocating engine with a compression ratio of 8.75:1. While the Indicator Diagram used would not have been true for the rotary engine 2, in the interest of a direct comparison, the same Indicator Diagram was used for both. The heat loss due to conduction and radiation to the chamber walls will be different for the two engines. The rotary engine 2 would still run a little hotter as it is oil cooled. Both these factors affect the graph.

The 1000 cc 1:1 ratio six teeth rotary engine 2 was compared with a four cylinder 2000 cc reciprocating engine because the reciprocating engine takes two revolutions to complete the four cycles and induct 2000 cc of combustible mixture. Consequently, a 2000 cc reciprocating engine inducts 1000 cc per revolution. The 1000 cc rotary engine 2 also inducts 1000 cc per revolution but completes the four cycles every revolution. The fuel usage is similar.

The torque output of the rotary engine 2 was calculated by first determining the effective area on which the pressure reacts. This effective area was then multiplied by the chamber pressure and by the average distance this effective area is from the centre of the drive shaft 4. The effective area of the male tooth 12, the chamber 26 volume and the moment to the shaft centre were determined by diagrams of the rotors 4, 8, at the progressive rotation angles. The cavities 14 of the female rotor 8 shade areas of the teeth 12 of the male rotor 4 from the pressure while they are engaged. Consequently, the effective area is constantly changing. The full area of the male tooth 12 is exposed to the pressure when the rotors 4, 8 disengage. The male tooth 12 is fully exposed to the pressure for substantially 60° of rotation.

The results shown in the graph in FIG. 11 are not intended to be absolute values and are for direct comparison only. The 1000 cc five cycle rotary engine 2 engine was found to have 146.4 newton-meters (108 ft.lb) average torque while the 2000 cc reciprocating engine averaged 121.6 newton-meters (90 ft.lb) torque, tending to indicate a nominal improvement of 20%. This improvement results from the improved mechanical geometry of the rotary engine 2.

The engine 2 has several advantages over an equivalent 2000 cc capacity four cylinder reciprocal engine. The power-to-weight and power-to-size ratios of the rotary engine are exceptional relative to that of a similar sized reciprocal engine. The major components of engine 2, when manufactured from steel and cast iron, were found to have a combined weight of 38 kg. This weight could be further reduced by using light-weight materials such as aluminium or magnesium alloys. It is thought using titanium to manufacture the shafts would result in the basic engine weighing about 25 kg.

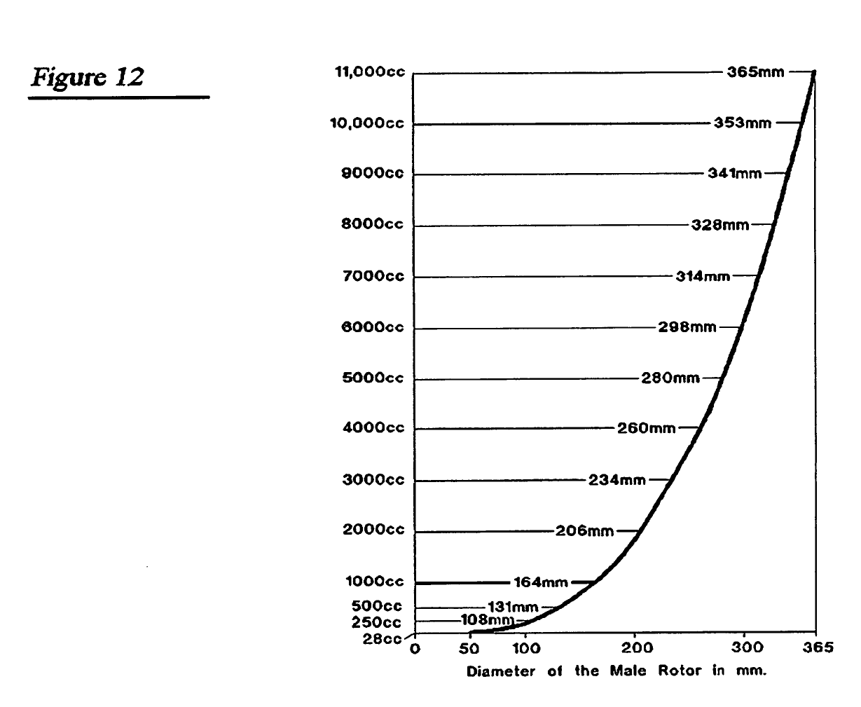

The 1000 cc capacity engine 2 provided as an example only has dimensions of approximately 420 mm wide×220 mm high×300 mm long, including an oversize air inlet system. The power-to size ratio of the rotary engine 2 increases with the capacity of the engine 2. FIG. 12 shows a graph of engine 2 capacity against male rotor 4 diameter. The male rotor 4 of the 1000 cc prototype (substantially equivalent to a 2000 cc reciprocal engine) version is 164 mm diameter. To double the capacity of the rotary engine 2 to 2000 cc (substantially equivalent to a 4000 cc reciprocal engine), a male rotor 4 diameter of 206 mm is required. Doubling the male rotor 4 diameter to 328 mm results in a capacity of 8000 cc (substantially equivalent to a 16,000 cc reciprocal engine).

It is expected that fuel economy will be also a feature of the engine. The graphs in FIG. 10 tend to indicate that the 1000 cc six teeth 1:1 ratio engine 2 would produce more power, per unit of fuel, than a typical equivalent 2000 cc reciprocating engine.

Additional to the 27% less thermal absorption area than its reciprocating counterpart, the engine 2 also gains the energy that would otherwise by consumed by the reciprocating action and the torque needed to drive the valve train. The engine also has relatively large air inlet ducts and inlet ports 48, 50 so the volumetric efficiency is expected to be exceptionally favourable. The centrifugal action associated with the fifth purging cycle further saves the energy used by a reciprocating engine to generate the low pressure needed during the inlet stroke.

The audible noise emitted will also be significantly reduced by the exclusion of the whole valve train and the far lower number of moving and interacting parts. Exhaust back-pressure does not affect the power output of the engine 2. This allows a very quiet exhaust system to be fitted to the engine 2.

It is also expected that the very small component count would reduce production cost considerably, with material usage being dramatically reduced. It is expected that the energy used to produce the engine 2 should also be very much less than that used to produce previously proposed engines. The rotary engine 2 has substantially twelve major components plus the seal arrays 170, 171. A comparable 2000 cc four cylinder reciprocating engine has substantially 48 major components. The mass of the engine 2 is correspondingly only about 20% of the comparable reciprocating engine. Consequently, raw material content would also be significantly less. It is anticipated that the rotary engine 2 would utilise much the same types of materials as those used in typical reciprocating engines.

It will also be appreciated that the exhaust back-pressure does not effect the torque output of the engine 2, making the engine 2 ideal for turbo-charging. It is considered the design of a turbocharger may well benefit from a higher available pressure. If a turbo-charger or supercharger were to be fitted, seven or eight teeth would be necessary, as the fifth purging cycle would need to be shortened to prevent the pre-compressed air entering during the purge cycle. The addition of two more inlet ports for turbo-charging just prior to the commencement of the compression cycle, would allow separate admission of the pre-compressed air.

Further, while the rotary engine 2 described has been designed to run on typically readily available petroleum fuels, it will appreciated that a rotary engine according to an embodiment of the present invention may be alternately designed to run on any liquid or gaseous fuel.

The above described embodiments of the present invention have been described by way of example only and it will be appreciated that modifications and variations may be made without departing from the spirit and scope of the invention described.

Throughout the specification, unless the context requires otherwise, the word “comprise”, and variations such as “comprises” or “comprising”, will be understood to imply the inclusion of a stated step or integer or group of steps or integers but not the exclusion of any other step or integer or group of steps or integers.

The reference to any prior art in this specification is not, and should not be taken as, an acknowledgement or any form of suggestion that that prior art forms part of the common general knowledge in any country.

1. A rotary engine comprising
a housing having a male rotor having a plurality of projecting lobes and a female rotor having a plurality of cavities, the male and female rotors being mounted for synchronous rotation about parallel axes such that during rotation successive lobes on the male rotor mate with successive cavities on the female rotor to define therewith a combustion chamber in which a mixture of air and fuel is compressed by the interaction of the lobe and the cavity during rotor rotation;
at least one exhaust port leading out of the housing for discharge of exhaust gases from the cavity of the female rotor following combustion and from the space between adjacent lobes of the male rotor following combustion; and
respective purge ports leading out of the housing downstream of the exhaust port in the direction of rotor rotation to facilitate discharge of residual exhaust gases from the cavity and inter-lobe space, the purge ports being associated with air inlet ports to admit air into the cavity and inter-lobe space in preparation for the subsequent combustion cycle.

2. The rotary engine as claimed in claim 1 comprising a separate exhaust port for the male and female rotor.

3. The rotary engine as claimed in claim 1, wherein the purge ports lead radially out of the housing to facilitate the discharge of the residual exhaust gases under the effect of centrifugal force generated by rotor rotation.

4. The rotary engine as claimed in claim 1, wherein the purge ports extend over a relatively large arc of the order of 90° to 120°.

5. The rotary engine as claimed in claim 1, wherein the intake ports are located in at least one of two end walls of the rotor housing.

6. The rotary engine as claimed in 5, wherein the intake ports are located in both end walls of the rotor housing.

7. The rotary engine as claimed in claim 1, further comprising
a male tip seal for providing sealing contact between the housing and one of said projecting lobes, the male tip seal being provided on the projecting lobe and substantially running along the length of the male rotor; and
a first landing zone provided on the housing following the combustion chamber; wherein
during rotation of the male and female rotors the male tip seal ceases to contact the housing in the region of the combustion chamber, and the first landing zone provides for the gradual re-engagement between the male tip seal and the housing after the male tip seal passes the combustion chamber.

8. The rotary engine as claimed in claim 7, further comprising an element for biasing the male tip seal in a substantially radial direction with respect to the male rotor away from the male rotor towards the housing.

9. The rotary engine as claimed in claim 8, wherein the element for biasing the male tip seal comprises a leaf spring.

10. The rotary engine as claimed in claim 7, wherein the male tip seal is mounted in a channel provided in the projecting lobe.

11. The rotary engine as claimed in claim 10, wherein the male tip seal has a shoulder portion that interacts with an undercut portion in the channel to limit the amount of movement of the male tip seal in a substantially radial direction with respect to the male rotor in the channel.

12. The rotary engine as claimed in claim 7, wherein the first landing zone is substantially 4 mm long.

13. The rotary engine as claimed in claim 7, wherein the first landing 20 zone is in the form of a curved ramp.

14. The rotary engine according to claim 1, further comprising
a leading female tip seal for providing sealing contact between the housing and an inter-cavity portion of the female rotor located between successive cavities of the female rotor, the first female tip seal being provided adjacent a leading corner of the inter-cavity portion and substantially running along the length of the female rotor; and
a second landing zone provided on the housing following the combustion chamber; wherein
during rotation of the male and female rotors the leading female tip seal ceases to contact the housing in the region of the combustion chamber, and the second landing zone provides for the gradual re-engagement between the leading female tip seal and the housing after the leading female tip seal passes the combustion chamber.

15. The rotary engine as claimed in claim 14, further comprising an element for biasing the leading female tip seal in a substantially radial direction with respect to the female rotor away from the female rotor towards the housing.

16. The rotary engine as claimed in claim 15, wherein the element for biasing the leading female tip seal comprises a leaf spring.

17. The rotary engine as claimed in claim 14, wherein the leading female tip seal is mounted in a leading channel provided in the inter-cavity portion.

18. The rotary engine as claimed in claim 17, wherein the leading female tip seal has a shoulder portion that interacts with an undercut portion in the leading channel to limit the amount of movement of the leading female tip seal in a substantially radial direction with respect to the female rotor in the leading channel.

19. The rotary engine as claimed in claim 14, wherein the second landing zone is substantially 4 mm long.

20. The rotary engine as claimed in claim 14, wherein the second landing zone is in the form of a curved ramp.

21. The rotary engine as claimed in claim 14, further comprising a trailing female tip seal for providing a sealing contact between the housing and the inter cavity portion between successive cavities of the female rotor, the trailing female tip seal being provided adjacent a trailing corner of the inter-cavity portion and substantially running along the length of the female rotor.

22. The rotary engine as claimed in claim 21, further comprising an element for biasing the trailing female tip seal substantially away from the female rotor towards the housing.

23. The rotary engine as claimed in claim 22, wherein the element for biasing the trailing female tip seal comprises a leaf spring.

24. The rotary engine as claimed in claim 20, wherein the trailing female tip seal is mounted in a trailing channel provided in the inter-cavity portion.

25. The rotary engine as claimed in claim 24, wherein the trailing female tip seal has a shoulder portion that interacts with an undercut portion in the trailing channel to limit the amount of movement of the trailing female tip seal in a radial direction with respect to the 5 female rotor in the trailing channel such that the trailing female tip seal does not substantially contact the second landing zone.

26. The rotary engine as claimed in claim 1, further comprising a first seal provided in a first channel in the male rotor; a second seal provided in a second channel of the male rotor, an end of the first channel meeting an end of the second channel; and a blocking element that is provided where the end of the first channel meets the end of the second channel for preventing exhaust gases entering these channels between the seals and the male rotor and from travelling from one of the first channel and the second 15 channel to the other of the first channel and the second channel.

27. The rotary engine as claimed in claim 26, further comprising a blocking biasing element for biasing the blocking element towards the housing away from the male rotor.

28. The rotary engine as claimed in claim 27, wherein the blocking biasing element is a coil spring.

29. The rotary engine as claimed in claim 26, wherein the blocking element is substantially a cylindrical shaped stopper.

30. The rotary engine as claimed in claim 26, wherein the blocking element is substantially a piston.

31. The rotary engine as claimed in claim 1, further comprising a first seal provided in a first channel in the female rotor;
a second seal provided in a second channel of the female rotor, an end of the first channel meeting an end of the second channel; and
a blocking element that is provided where the end of the first channel meets the end of the second channel for preventing exhaust gases entering these channels between the seals and the female rotor and from travelling from one of the first channel and the second channel to the other of the first channel and the second channel.

32. The rotary engine as claimed in claim 31, further comprising a blocking biasing element for biasing the blocking element towards the housing away from the female rotor.

33. The rotary engine as claimed in claim 32, wherein the blocking biasing element is a 20 coil spring.

34. The rotary engine as claimed in claim 31, wherein the blocking element is substantially a cylindrical shaped stopper.

35. The rotary engine as claimed in claim 31, wherein the blocking element is substantially a piston.

36. A rotary engine comprising
at least one rotor enclosed in a housing, the rotor having at least one tip that contacts a portion of the housing during rotation, the tip ceasing to contact the housing in the region of a combustion chamber as the rotor the tip passes the combustion chamber during rotation of the rotor; wherein
a landing zone is provided in the housing to provide for the gradual re-engagement between the tip and said portion of the housing after the tip passes the combustion chamber.

37. The rotary engine as claimed in claim 36, further comprising an element for biasing the tip substantially radially with respect to the rotor away from the rotor towards the housing.

38. The rotary engine as claimed in claim 37, wherein the element for biasing the tip comprises a leaf spring.

39. The rotary engine as claimed in claim 36, wherein the tip is mounted in a channel provided in the rotor.

40. The rotary engine as claimed in claim 39, wherein the tip has a shoulder portion that interacts with an undercut portion in the channel to limit the amount of movement of the tip in a substantially radial direction with respect to the rotor in the channel.

41. The rotary engine as claimed in claim 36, wherein the landing zone is substantially 4 mm long.

42. The rotary engine as claimed in claim 36, wherein the landing zone is in the form of a curved ramp.

43. A rotary engine comprising
at least one rotor;
a first seal provided in a first channel in the rotor;
a second seal provided in a second channel of the rotor, an end of the first channel meeting an end of the second channel; and
a blocking element that is provided in the region where the end of the first channel meets the end of second channel for preventing exhaust gases generated during a combustion cycle of the rotary engine from entering said channels between the seals and the rotor.

44. The rotary engine as claimed in claim 43, further comprising a blocking biasing element for biasing the blocking element towards the housing away from the rotor.

45. The rotary engine as claimed in claim 44, wherein the blocking biasing element is a coil spring.

46. The rotary engine as claimed in claim 43, wherein the blocking 5 element is substantially a cylindrical shaped stopper.

47. The rotary engine as claimed in claim 43, wherein the blocking element is substantially a piston.
